(19) United States
(12) Patent Application Publication
(10) Pub. No.: US 2020/0173085 A1
(43) Pub. Date: Jun. 4, 2020

(54) ULTRASONIC TEXTILE PROCESSING WASH BOXES, PROCESSING LINES AND RELATED METHODS

(71) Applicant: Consultex, Inc., Spartanburg, SC (US)

(72) Inventor: Arne W. Niemann, Spartanburg, SC (US)

(73) Assignee: Consultex, Inc., Spartanburg, SC (US)

(21) Appl. No.: 16/629,266

(22) PCT Filed: Jul. 9, 2018
(86) PCT No.: PCT/US2018/041338

§ 371 Date: Jan. 7, 2020

Related U.S. Application Data
(60) Provisional application No. 62/530,010, filed on Jul. 7, 2017.

(51) Int. Cl. D06F 19/00; D06F 35/00; D06B 3/10; D06B 3/12; D06B 3/20; D06B 13/00; B08B 3/12

(52) U.S. Cl. CPC D06F 19/00; D06F 35/006; D06B 3/105; D06B 15/025; D06B 3/205; D06B 13/00; B08B 3/123; D06B 3/12

(57) ABSTRACT

Ultrasonic wash boxes, processing lines, and related methods are provided herein. A wash box can include a housing having a first side wall, a second side wall, a first end wall and a second end wall. The housing can have an opening formed between the side wall and the end walls. The wash box can include a first ultrasonic field generator secured to a first side wall of the housing and a second ultrasonic field generator secured to the second side wall of the housing. The wash box can also include a fabric guide carriage insertable within the opening of the housing between the first and second side walls.

### RELATED APPLICATION

The presently disclosed subject matter claims the benefit of U.S. Provisional Patent Application Ser. No. 62/530,010, filed Jul. 7, 2017, the disclosure of which is incorporated herein by reference in its entirety.

### TECHNICAL FIELD

The present subject matter relates to ultrasonic textile processing wash boxes and processing lines and related methods. In particular, the present subject matter relates to wash box for the continuous processing of textiles using ultrasonic technology.

### BACKGROUND

Ultrasound technology has been used for washing flexible textiles for a few years. These systems have not achieved as much commercial success possibly because they have significant inconveniences. In some embodiments of wash boxes that use ultrasound technology, the use of a large volume of liquid in such systems tends to be needed due to the fact that it is hard to achieve a homogeneous distribution of the acoustic field in an entire washing volume. High energy use has been needed in the past so that the cavitation threshold is reached and cleaning of the textile material can occur.

In some embodiments, the washing time is increased so that treatment can be done with a low proportion of textile material to be washed per volume of liquid. However, this textile material must be moved so that it passes through the areas of maximum energy of the washing cavitation or well. Additionally, there are other difficulties that come from the gas content in the liquid and from the presence of bubbles between the materials to be washed. In fact, to achieve good results in such wash boxes, it has been found that degassing of the liquid should occur so that the concentration of gas in the liquid is less than 50% of the saturation concentration.

Other issues arise depending on the type of fabric being treated, for example, particularly with three-dimensional fabrics, having a recognizable thickness along with a length and a width. For example, circular knit fabrics are formed in a tubular configuration. During processing, the tubular form of the circular knit can be slit for processing, including, but not limited to, dyeing, finishing, cutting and sewing operations for apparel manufacturing. Whether kept in tubular form so that the circular knit has a double fabric thickness when processed or slit to form a single fabric thickness, the circular knitted fabrics present a challenge for washing due to the fact that tension normally exerted on a fabric within a wash box causes undue stretching in the knitted fabric. When treating the circular knitted fabric in tubular form, the fabric thickness is doubled with two faces of the fabric within the interior area of the tubular. This configuration can create an issue during treatment where the treatment may not effectively treat all of the circular knitted fabric in tubular form. In particular, the interior faces of the circular knitted fabric in tubular form may not receive the same exposure to the treatment fluids as the exterior faces of the fabric. If the circular knitted fabric in tubular form is slit to form a single width knitted fabric, the faces of the fabric are likely more evenly treated but the issue used by tension can increase. When tension is exerted on the single layered fabric, the fabric is much more likely to stretch past a state of resilient recovery. Additionally, the stretching of the single layered knitted fabric will likely cause the fabric to curl in the direction of the stretch. Other three-dimensional fabrics, such as tufted fabrics or carpet, terry cloth fabrics, or three-dimensional woven fabrics can create treatment penetration issues for conventional wash box technologies as well.

The previous problems have created practical limitations which, up until now, have hindered the industrial-commercial development of ultrasonic systems for washing of textiles materials. Nowadays, in some embodiments, conventional washing processes that require elaborate handling systems process the textile materials in batches. This processes require a significant consumption of water, detergent and energy are used in industrial laundries. Continuous ultrasonic washing processes which at times have been tried to be introduced have not been as successful due to the low level of cleaning achieved when compared to traditional washing methods.

As such, a need exists for improved process and ultrasonic wash boxes and systems that can help reduce the energy use and improve cleaning of the textile material while maintaining or improving processing time.

### SUMMARY

The present subject matter provides ultrasonic textile processing wash boxes and processing lines and related methods. In particular, wash boxes and processing lines are disclosed that provide the continuous processing of textiles using ultrasonic technology. Such continuous textile processing can be wet processing, or in some case, dry processing. Methods related to the manufacture and use of such wash boxes, processing lines and systems as disclosed herein are also provided.

Thus, it is an object of the presently disclosed subject matter to provide wash boxes and systems for the continuous processing of textiles using ultrasonic technology and methods related to such wash boxes and systems. While one or more objects of the presently disclosed subject matter having been stated hereinabove, and which is achieved in whole or in part by the presently disclosed subject matter, other objects will become evident as the description proceeds when taken in connection with the accompanying drawings as best described hereinbelow.

### BRIEF DESCRIPTION OF THE DRAWINGS

A full and enabling disclosure of the present subject matter including the best mode thereof to one of ordinary skill in the art is set forth more particularly in the remainder of the specification, including reference to the accompanying figures, in which:

FIG. 1A illustrates a cross-sectional side view of an embodiment of an ultrasonic wash box that can be used with woven fabrics, for example, according to the present subject matter;

FIG. 1B illustrates a perspective view of the embodiment of the ultrasonic wash box according to FIG. 1A;

FIG. 1C illustrates a cross-sectional side view of an embodiment of an ultrasonic wash box that can be used with knitted fabrics, for example, according to the present subject matter;

FIG. 1D illustrates a perspective view of the embodiment of the ultrasonic wash box according to FIG. 1C;

FIG. 2A illustrates a cross-sectional side view of an embodiment of a processing line that can comprise two ultrasonic wash boxes according to the present subject matter;

FIG. 2B illustrates a perspective view of the embodiment of the processing line comprising ultrasonic wash boxes according to FIG. 2A;

FIG. 3A illustrates a cross-sectional side view of an embodiment of a processing line that can comprise three ultrasonic wash boxes according to the present subject matter;

FIG. 3B illustrates a perspective view of the embodiment of the processing line comprising ultrasonic wash boxes according to FIG. 3A; and

FIG. 4 illustrates a perspective view of an embodiment of a processing line that can comprise embodiments of multiple ultrasonic wash boxes and a squeezing device according to the present subject matter.

FIG. 5 illustrates a cross-sectional side view of another embodiment of an ultrasonic wash box that can be used with fabrics, for example, according to the present subject matter;

FIG. 6 illustrates a cross-sectional side view of an additional embodiment of an ultrasonic wash box that can be used with fabrics, for example, according to the present subject matter;

FIG. 7 illustrates a cross-sectional side view of a further embodiment of an ultrasonic wash box that can be used with fabrics, for example, according to the present subject matter;

FIG. 8 illustrates a cross-sectional side view of another embodiment of an ultrasonic wash box that can be used with fabrics, for example, according to the present subject matter;

FIG. 9A illustrates a front plan view of an embodiment of a wash box in accordance with the present subject matter that includes an embodiment of a carriage guidance system that is holding an embodiment of a fabric guide carriage in an upward, or fabric threading, position; and

FIG. 9B illustrates a front plan view of the embodiment of the wash box according to FIG. 9A with the carriage guidance system having the fabric guide carriage in an downward, or operating, position; and

FIG. 9C illustrates a side perspective view of a portion of the embodiment of the wash box according to FIGS. 9A and 9B showing portion of the carriage guidance system and portion of the fabric guide carriage.

Repeat use of reference characters in the present specification and drawings is intended to represent the same or analogous features or elements of the present subject matter.

### DETAILED DESCRIPTION

Reference now will be made to the embodiments of the present subject matter, one or more examples of which are set forth below. Each example is provided by way of an explanation of the present subject matter, not as a limitation. In fact, it will be apparent to those skilled in the art that various modifications and variations can be made in the present subject matter without departing from the scope or spirit of the present subject matter. For instance, features illustrated or described as one embodiment can be used on another embodiment to yield still a further embodiment. Thus, it is intended that the present subject matter cover such modifications and variations as come within the scope of the appended claims and their equivalents. It is to be understood by one of ordinary skill in the art that the present discussion is a description of exemplary embodiments only, and is not intended as limiting the broader aspects of the present subject matter, which broader aspects are embodied in exemplary constructions.

Although the terms first, second, right, left, front, back, etc. may be used herein to describe various features, elements, components, regions, layers and/or sections, these features, elements, components, regions, layers and/or sections should not be limited by these terms. These terms are only used to distinguish one feature, element, component, region, layer or section from another feature, element, component, region, layer or section. Thus, a first feature, element, component, region, layer or section discussed below could be termed a second feature, element, component, region, layer or section without departing from the teachings of the disclosure herein.

Similarly, when a layer or coating is being described in the present disclosure as “on” or “over” another layer or substrate, it is to be understood that the layers can either be directly contacting each other or have another layer or feature between the layers, unless expressly stated to the contrary. Thus, these terms are simply describing the relative position of the layers to each other and do not necessarily mean “on top of” since the relative position above or below depends upon the orientation of the device to the viewer.

Embodiments of the subject matter of the disclosure are described herein with reference to schematic illustrations of embodiments that may be idealized. As such, variations from the shapes and/or positions of features, elements or components within the illustrations as a result of, for example but not limited to, user preferences, manufacturing techniques and/or tolerances are expected. Shapes, sizes and/or positions of features, elements or components illustrated in the figures may also be magnified, minimized, exaggerated, shifted or simplified to facilitate explanation of the subject matter disclosed herein. Thus, the features, elements or components illustrated in the figures are schematic in nature and their shapes and/or positions are not intended to illustrate the precise configuration of the subject matter and are not intended to limit the scope of the subject matter disclosed herein.

It is to be understood that the ranges and limits mentioned herein include all ranges located within the prescribed limits (i.e., subranges). For instance, a range from about 100 to about 200 also includes ranges from 110 to 150, 170 to 190, 153 to 162, and 145.3 to 149.6. Further, a limit of up to about 7 also includes a limit of up to about 5, up to 3, and up to about 4.5, as well as ranges within the limit, such as from about 1 to about 5, and from about 3.2 to about 6.5 as examples.

As disclosed herein, a wash box is provided for the continuous processing of textiles using ultrasonic technology. In particular, the wash boxes can utilize two or more ultrasonic transducers positioned on or within a wash box, such as attached to the side walls, end walls or bottom, or suspended between the side walls and end walls. In some embodiments, the wash boxes can utilize two opposing and/or offset ultrasonic transducers on either side of the box housing creating two ultrasonic fields within the wash box. These ultrasonic transducers can be secured to the outside of the wash boxes or can be submerged within the wash boxes. These wash boxes can to be used in various textile processes, including but not limited to dyeing, rinsing, washing, bleaching, mercerizing, desizing, or the like.

In particular, the present disclosures can provide a wash box that comprises a housing having a first side wall, a second side wall, a first end wall and a second end wall as well as a bottom. The side and end walls of the housing forms an upward facing opening in the housing in which the fabrics to be treated are processed. The wash box comprises a first ultrasonic field generator and a second ultrasonic field generator. In some embodiments, the first ultrasonic field generator can be secured to the first side wall of the housing and the second ultrasonic field generator can be secured to the second side wall of the housing. The ultrasonic field generators are configured on the side walls to create two ultrasonic wave fields. Further, the ultrasonic wash box comprises a fabric guide carriage that can be inserted within the opening of the housing between the first and second side walls. The fabric guide carriage can comprise a frame that holds rollers and/or guide bars around which the fabric can be looped to aid in forming the fabric travel path through which the fabric travels. In some embodiments, one or mere of the ultrasonic field generators can be secured to the fabric guide carriage. In some embodiments, one or more of the ultrasonic field generators can be secured to the fabric guide carriage and the first and/or second side walls.

The first ultrasonic field generator and the second ultrasonic field generator can be transducers that can convert electrical energy into ultrasonic wavelengths. In some embodiments, the first ultrasonic field generator can be offset from the second ultrasonic field generator. For example, in some embodiments, the first ultrasonic field generator can be positioned at the top portion of the first side wall of the housing and the second ultrasonic field generator is positioned at a lower portion of the second side wall of the housing. In some embodiments, the second ultrasonic field generator is positioned at the top portion of the second side wall of the housing and the first ultrasonic field generator is positioned at a lower portion of the first side wall of the housing. During operation, either the first ultrasonic field generator or the second ultrasonic field generator may be turned off while the other operates. Alternatively, both the first ultrasonic field generator and the second ultrasonic field generator can operate at the same time. Further when both ultrasonic field generators are operating, the power intensities can be adjusted for one or both ultrasonic field generators depending on various parameters, including but not limited to, the fabric being processed, the process being performed and the intended results of the processing.

The fabric guide carriage can be configured in different ways to facilitate movement of the fabric within the wash box and the ultrasonic wave fields that are used to treat the fabric within different processes. The type and configuration of fabric guide carriage can depend on the type of process being performed in the respective wash boxes, the types of chemicals and recipes being used, the type of fabrics being processed as well as the speed at which the fabric is being processed.

In some embodiments, the fabric guide carriage can be detachable and removable from the housing so that the cleaning of the rollers, guide bars, and carriage can be more efficiently accomplished. Further, the liquor used in the wash box may be more easily changed and the wash box can be more easily cleaned. In some embodiments, the fabric guide carriage can be removable from the opening or mouth of the housing and can be insertable back into the opening of the housing. To facilitate cleaning of the fabric guide carriage and the housing and the threading of the fabric, the fabric guide carriage can be attachable and detachable from the housing.

As stated above, the fabric guide carriage can comprise one or more rollers around which a fabric is guided within a fabric travel path. Further, the fabric guide carriage comprises guide bars around which fabric may be looped along a fabric travel path.

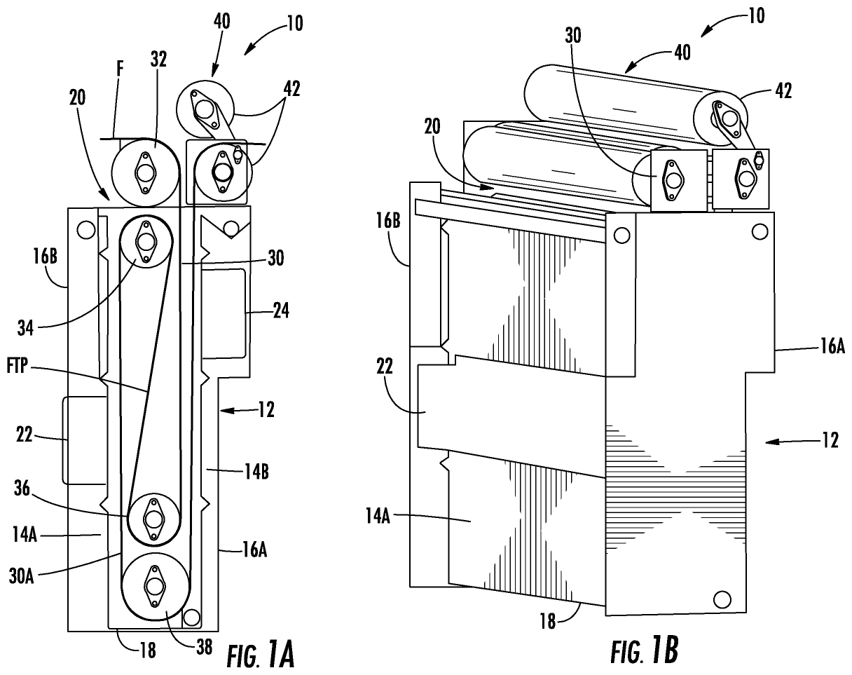

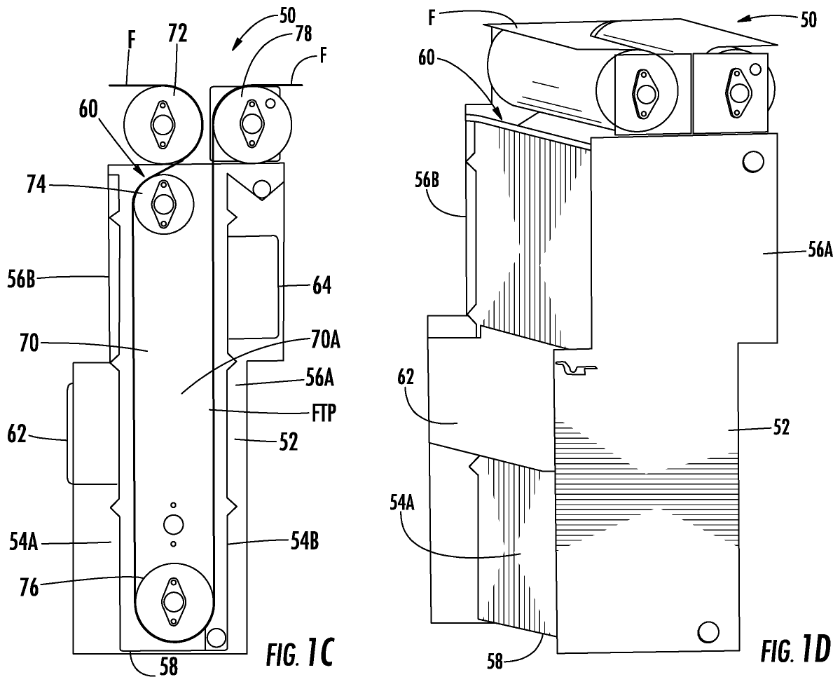

As shown in FIGS. 1A and 1B, a wash box 10, which can be used with woven fabrics, can be provided that comprises a housing 12 having a first side wall 14A, a second side wall 14B, a first end wall 16A and a second end wall 16B as well as a bottom 18. The side and end walls 14A, 14B, 16A, 16B of the housing 12 forms an upward facing opening 20 in the housing 12 in which the fabrics F be treated are processed. The first side wall 14A can be considered the face side of wash box 10 and the second side wall 14B can be considered the rear side of wash box 10. The wash box 10 can also comprise a first ultrasonic field generator 22, which can be an ultrasonic transducer, secured to the first side wall 14A of the housing 12 and a second ultrasonic field generator 24, which can also be an ultrasonic transducer, secured to the second side wall 14B of the housing 14. The ultrasonic field generators 22, 24 can be configured on the side walls 14A, 14B to create two ultrasonic wave fields. Further, the ultrasonic wash box 10 can comprise a fabric guide carriage 30 that can be inserted within the opening 20 of the housing 12 between the first and second side walls 14A 14B. The fabric guide carriage 30 can comprise a frame 30A that holds rollers 32, 34, 36, 38 around which the fabric F can be looped to aid in forming the fabric travel path FTP through which the fabric F travels. A squeezing device 40 can be positioned above the opening 20 through which the fabric can pass before traveling to next process in a textile processing line. The squeezing device 40 can comprise a pair of rollers 42 can remove excess process liquor from the fabric.

As shown in FIGS. 1C and 1D, a wash box 50 can be provided that can be used to process knit fabrics or other types of fabrics. The wash box 50 can comprise a housing 52 having a first side well 54A, a second side wall 54B, a first end wall 56A and a second end wall 56B as well as a bottom 58. The side and end walls 54A, 54B, 56A, 56B of the housing 52 forms an upward facing opening 60 in the housing 52 in which the fabrics F be treated are processed. The first side wall 54A can be considered the face side and the second side wall 54B can be considered the rear side. The wash box 50 can also comprise a first ultrasonic field generator 62, which can be an ultrasonic transducer, secured to the first side well 54A of the housing 52 and a second ultrasonic field generator 64, which can also be an ultrasonic transducer, secured to the second side wall 54B of the housing 54. The ultrasonic field generators 62, 64 can be configured on the side walls 54A, 54B to create two ultrasonic wave fields. Further, the ultrasonic wash box 50 can comprise a fabric guide carriage 70 that can be inserted within the opening 60 of the housing 52 between the first and second side walls 54A, 54B. The fabric guide carriage 70 can comprise a frame 70A that holds rollers 72, 74, 76, 78 around which the fabric F can be looped to aid in forming the fabric travel path FTP through which the fabric F travels. As shown in FIGS. 1A and 1C, the positions of the rollers within the respective fabric guide carriages can dictate the travel path of the fabric in relation of the ultrasonic transducers used to generate the ultrasonic fields.

The ultrasonic field generators 62, 64 can emit ultrasonic wavefields in a range of frequencies and the intensities at which the ultrasonic field generators 62, 64 can emit the ultrasonic wave fields at the specific frequencies can be adjustable. Once the ultrasonic wave field for each ultrasonic field generator 62, 64 is selected for the specific use which can including but is not limited to, the fabric being processed, the process being performed and the intended results of the processing, each of the ultrasonic field generators 62, 64 that will be implemented in the wash box 10 will be configured to emit the respective specified frequency. Thus, each of the ultrasonic field generators can be selected based on the frequency that each is to emit. For example, the frequency at which each of the ultrasonic field generators 62, 64 emits an ultrasonic wave field can be within a range from about 10 kHz to about 120 kHz. In some embodiments, the ultrasonic field generators 62, 64 can emit an ultrasonic wave field within a range from about 15 kHz to about 100 kHz. In some embodiments, the ultrasonic field generators 62, 64 can emit an ultrasonic wave field within a range from about 20 kHz to about 80 kHz. In some embodiments, the ultrasonic field generators 62, 64 can emit an ultrasonic wave field within a range from about 25 kHz to about 40 kHz.

In some embodiments, the first ultrasonic field generator 62 and the second ultrasonic field generator 64 that are implemented can be configured to emit ultrasonic wave field at different frequencies. For example, in some embodiments, the first ultrasonic field generator 62 that is implemented can emit an ultrasonic wave field of about 25 kHz, while the second ultrasonic field generator 64 that is implemented can emit an ultrasonic wave field of about 40 kHz. Similarly, in some embodiments, the first ultrasonic field generator 62 that is implemented can emit an ultrasonic wave field of about 40 kHz while the second ultrasonic field generator 64 that is implemented can emit an ultrasonic wave field of about 25 kHz. In some embodiments, the first ultrasonic field generator 62 that is implemented can emit higher frequency and the second ultrasonic field generator 64 that is implemented can emit a lower frequency or vice versa. In some embodiments, the ultrasonic field generators 62, 64 that are implemented can emit ultrasonic wave fields with the same frequency or similarly frequencies. The power intensities of each ultrasonic field generators 62, 64 described above can also be adjustable to change the intensity of the ultrasonic wave field created. For example, in some embodiments the power intensities of each ultrasonic field generators 62, 64 described above can be adjustable between about 0% to about 100% intensity.

Thus, the ultrasonic wash boxes described above can be used as a single wash box or in combination with one or more other wash boxes to form a washing range or a processing line. Further, the ultrasonic wash boxes can be used with other process equipment that perform different functions to form a processing line for wet treatment of textile fabrics.

For example, a fabric processing line can comprise one or more wash boxes, wherein each wash box that comprises a housing having a first side wall, a second side wall, a first end wall and a second end wall as well as a bottom. The side and end walls of the housing forms an upward facing opening in the housing in which the fabrics be treated are processed. The wash box comprises a first ultrasonic field generator secured to the first side wall of the housing and a second ultrasonic field generator secured to the second side wall of the housing. The ultrasonic field generators are configured on the side walls to create two ultrasonic wave fields. Further, the ultrasonic wash box comprises a fabric guide carriage that can be inserted within the opening of the housing between the first and second side walls, the fabric guide carriage can comprise a frame that holds rollers and/or guide bars around which the fabric can be looped to aid in forming the fabric travel path through which the fabric travels. Depending on the type of process to be performed on the fabric that travels along the fabric travel path of the processing line, one or more wash boxes may be used.

In some embodiments of the processing line on each wash box, the first ultrasonic field generator can be on a top portion of the first side wall of the housing and the second ultrasonic field generator can be on a lower portion of the second side wall of the housing such that the first ultrasonic field generator can be offset from the second ultrasonic field generator. In some embodiments of the processing line on each wash box, the second ultrasonic field generator can be on a top portion of the second side wall of the housing and the first ultrasonic field generator is on a lower portion of the first side wall. Such ultrasonic wash boxes can be used in combination with a variety of other equipment in a processing line as described further below to treat and process a variety of different fabrics in a variety of different processes.

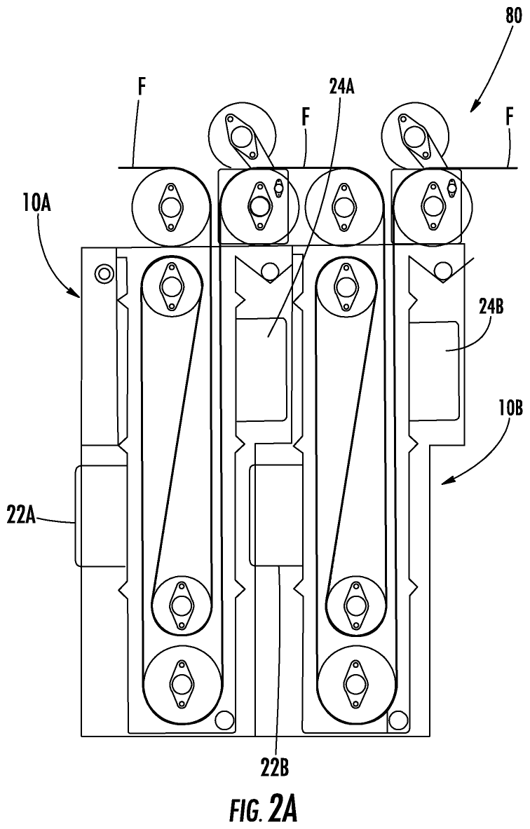

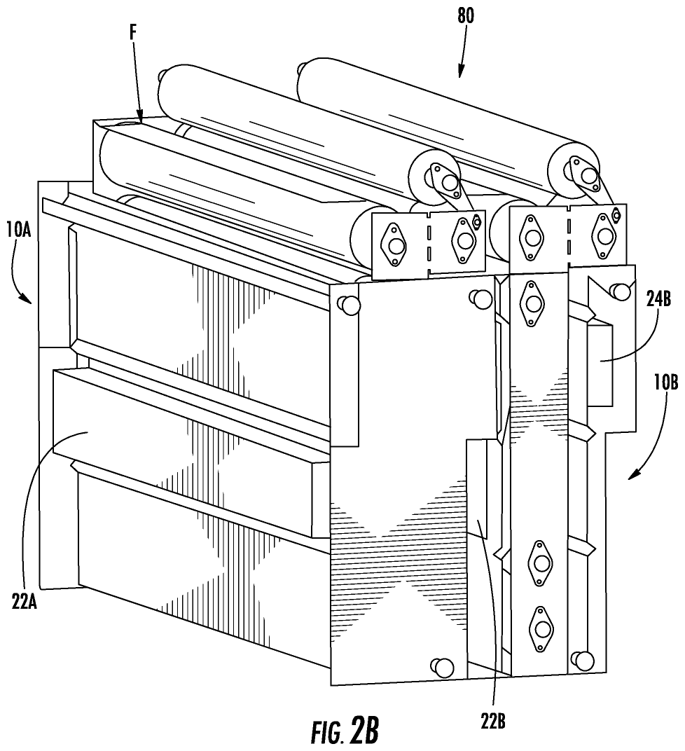

As stated above, multiple wash boxes can be used within a textile processing line. As shown FIGS. 2A and 2B, an embodiment of a processing line, generally designated 80, is provided that can comprise two wash boxes 10A and 10B positioned side by side. The two wash boxes 10A and 10B are constructed in a similar manner to the wash box 10 shown in FIGS. 1A and 1B and described in detail above. The ultrasonic field generators 22A, 24A of the wash box 10A can be configured on the side walls of the wash box 10A to create one or two ultrasonic wave fields within the interior of the wash box 10A as the fabric F being processed passes through the wash box 10A. Further, the ultrasonic field generators 22B, 24B of the wash box 10B can be configured on the side walls of the wash box 10B to create one or two ultrasonic wave fields within the interior of the wash box 10B as the fabric F being processed passes through the wash box 10B. In some embodiments, each wash box 10A and 10B can be configured to perform a different processing step and can contain different process liquors. In some embodiments, each wash box 10A and 10B can be configured to perform the same processing step and can contain the same process fluid, or process liquor.

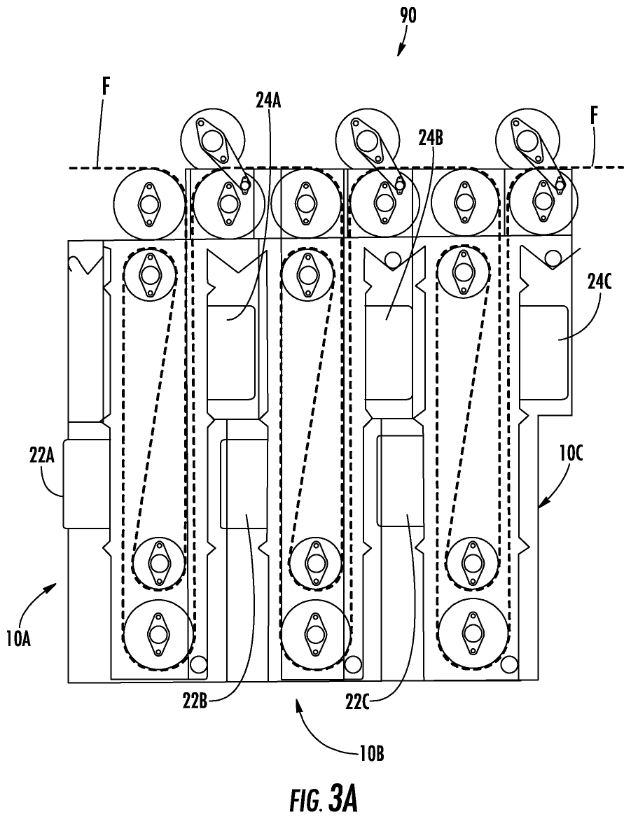

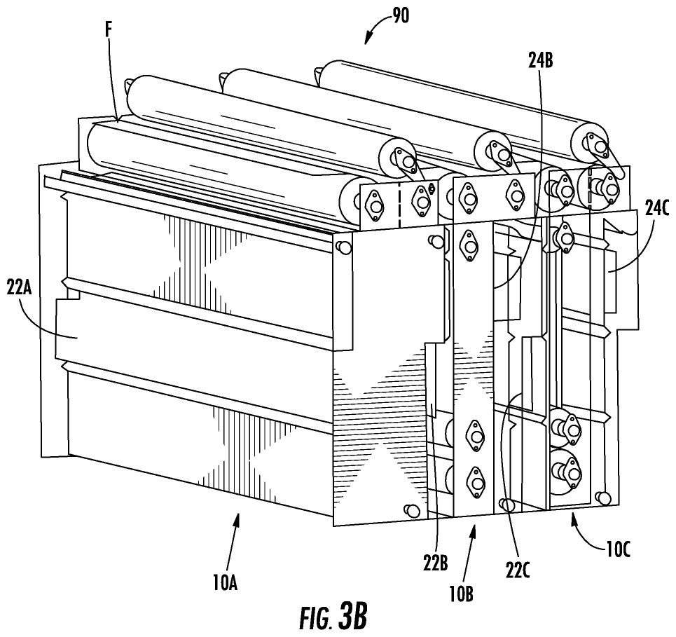

Referring to FIGS. 3A and 3B, another embodiment of a processing line, generally designated 90, is provided that can comprise three wash boxes 10A, 10B, and 10C positioned side by side. As above, the wash boxes 10A, 10B, and 10C are constructed in a similar manner to the wash box 10 shown in FIGS. 1A and 1B and described in detail above. The ultrasonic field generators 22A, 24A of the wash box 10A can be configured on the side walls of the wash box 10A to create one or two ultrasonic wave fields within the interior of the wash box 10A as the fabric F being processed passes through the wash box 10A. Additionally, the ultrasonic field generators 22B, 24B of the wash box 10B can be configured on the side walls of the wash box 10B to create one or two ultrasonic wave fields within the interior of the wash box 10B as the fabric F being processed passes through the wash box 10B. Further, the ultrasonic field generators 22C, 24C of the wash box 10C can be configured on the side walls of the wash box 10C to create one or two ultrasonic wave fields within the interior of the wash box 10C as the fabric F being processed passes through the wash box 10C. In some embodiments, each wash box 10A, 10B, and 10C can be configured to perform a different processing step and can contain different process liquors. In some embodiments, each wash box 10A, 10B, and 10C can be configured to perform the same processing step and can contain the same process liquor.

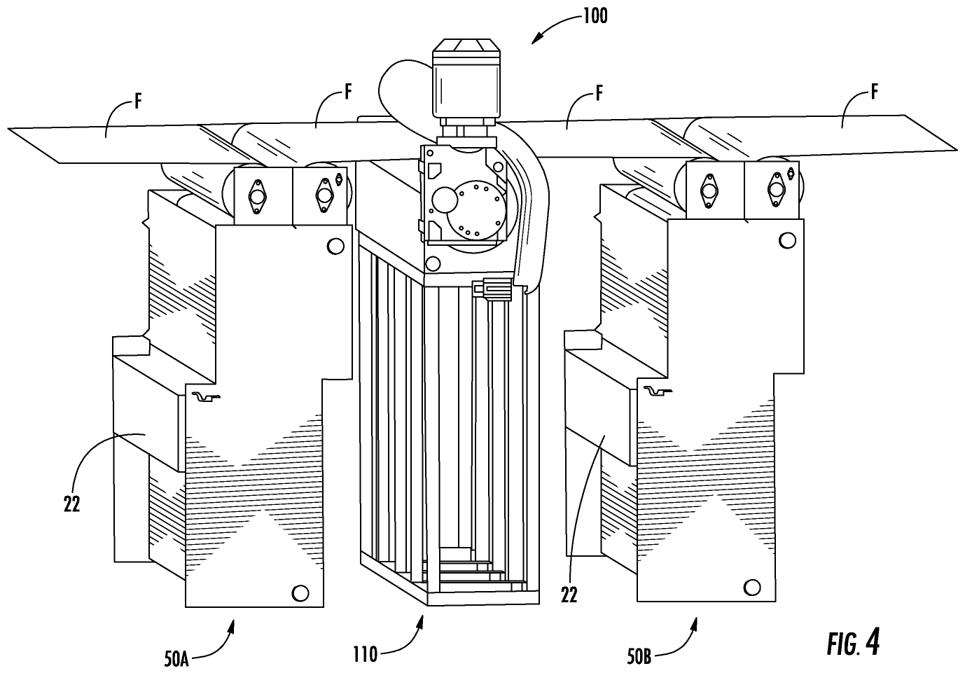

Referring to FIG. 4, another embodiment of a processing line, generally designated 100, is provided. The processing line 100 can comprise two wash boxes 50A and 50B with a squeezing device 110 positioned between the wash boxes 50A and 50B. The two wash boxes 50A and 50B are constructed in a similar manner to the wash box 50 shown in FIGS. 1C and 1D and described in detail above. In some embodiments, each wash box 10A and 10B can be configured to perform a different processing step and can contain different process liquors. As the fabric F is processed through the first wash box 50A, the ultrasonic field generators, 62, 64 (see FIG. 1C) of the first wash box 50A can create one or two ultrasonic fields that facilitate the treatment of the fabric within the liquor contained within first wash box 50A. The fabric can then pass through the rollers of the squeezing device 110 to remove the excess process liquor from the first wash box 50A from the fabric F. The fabric F can then pass through the second wash box 50B. The ultrasonic field generators, 62, 64 (see FIG. 1C) of the second wash box 50B can also generate one or two ultrasonic fields that facilitate the treatment of the fabric F within the second liquor contained within second wash box 50B.

As shown in FIG. 5, a cross-sectional view of a wash box 120 that can be provided which can be used to process conventional single-layered fabrics or multiple layered fabrics, as well as three-dimensional fabrics, such as 3-dimensional woven, tufted or knit fabrics. The wash box 120 can comprise a housing 122 having a first side wall 124A, a second side wall 124B, a first end wall and a second end wall (not shown in FIG. 5) as well as a bottom 126. The side walls 124A, 124B and end walls of the housing 122 forms an upward facing opening 128 in the housing 122 in which a fabric F to be treated can be inserted into a well of the housing 122 and processed. The first side wall 124A can be considered the face side and the second side wall 124B can be considered the rear side. Further, the ultrasonic wash box 120 can comprise a fabric guide carriage 130 that can be inserted within the opening 128 of the housing 122 between the first and second side walls 124A, 124B. The fabric guide carriage 130 can comprise a frame 130A (shown in dashed lines) that holds guide feed roller 132, which can be driven, a bottom guide roller 134, driven nip/squeeze rollers 136,138 around which the fabric F can be looped to aid in forming the fabric travel path FTP through which the fabric F travels in the direction F_{D}. By having no additional travel path rollers or guidance bars, the fabric only travels over the bottom positioned feed roller 132 and the around the bottom guide roller 134 and up to the driven squeeze rollers 136,138. This reduction in the change of directions the fabric F travels results in the reduction in the amount of tension placed on the fabric F.

The wash box 120 can also comprise a first ultrasonic field generator 140A, which can be an ultrasonic transducer, secured to the first side wall 124A of the housing 122 and a second ultrasonic field generator 140B, which can also be an ultrasonic transducer, secured to the carriage 130 above the bottom roller 134. The first ultrasonic field generators 140A can be configured on the side wall 124A and the second ultrasonic field generators 140B can be configured on the carriage 130 to create two, or dual, offset ultrasonic wave fields. The second ultrasonic field generator 140B is inserted into the wash box and thereby the treatment fluid within the wash box when in use. For wash box 120, the first ultrasonic field generator 140A can be positioned to create an ultrasonic wave field that is primarily emitted in a direction B_{FD} that initially encounters a first face FF₁ of the fabric F or, in the case of a fattened tubular circular knitted fabric, a first layer of the tubular fabric. The second ultrasonic field generator 140B can be positioned to create an ultrasonic wave field that is primarily emitted in a direction A_{FD} that initially encounters a second, opposing face FF₂ of the fabric F or, in the case of a fattened tubular circular knitted fabric, a second layer of the tubular fabric. By being offset in the positioning of the ultrasonic field generators 140A, 140B, possible interference between the two ultrasonic fields emitted in opposing directions A_{FD}, B_{FD} can be mitigated.

As above, the ultrasonic field generators 140A, 140B can emit a specific ultrasonic wave field within a range of frequencies depending on the ultrasonic field generators selected for use in the wash box and the intensities at which the ultrasonic field generators 140A, 140B can emit the ultrasonic wave fields at the specific frequencies can be adjustable. Once the ultrasonic wave field for each ultrasonic field generator 140A, 140B is selected for the specific use, each of the ultrasonic field generators 140A, 140B that will be implemented in the wash box 120 will be configured to emit the respective specified frequency. For example, ultrasonic field generators 140A, 140B can emit an ultrasonic wave field within a range from about 10 kHz to about 120 kHz. In some embodiments, the ultrasonic field generators 140A, 140B can emit an ultrasonic wave field within a range from about 15 kHz to about 100 kHz. In some embodiments, the ultrasonic field generators 140A, 140B can emit an ultrasonic wave field within a range from about 20 kHz to about 80 kHz. In some embodiments, the ultrasonic field generators 140A, 140B can emit an ultrasonic wave field within a range from about 25 kHz to about 40 kHz.

In some embodiments, the first ultrasonic field generator 140A and the second ultrasonic field generator 140B that are implemented can be configured to emit an ultrasonic wave field at different frequencies. For example, in some embodiments, the first ultrasonic field generators 140A that is implemented can emit an ultrasonic wave field of about 25 kHz while the second ultrasonic field generator 140B that is implemented can emit an ultrasonic wave field of about 40 kHz. Similarly, in some embodiments, the first ultrasonic field generators 140A that is implemented can emit an ultrasonic wave field of about 40 kHz while the second ultrasonic field generator 140B that is implemented can emit an ultrasonic wave field of about 25 kHz. In some embodiments, the first ultrasonic field generators 140A that is implemented can emit a higher frequency and the second ultrasonic field generator 140B that is implemented can emit a lower frequency or vice versa. In some embodiments, the ultrasonic field generators 140A, 140B that is implemented can emit ultrasonic wave field with the same frequency or similarly frequencies. The power intensities of each ultrasonic field generators 140A, 140B described above can also be adjustable to change the intensity of the ultrasonic wave field created. For example, in some embodiments, the power intensities of each ultrasonic field generators 140A, 140B described above can be adjustable between about 0% to about 100% intensity.

As within other embodiments described herein the ultrasonic wash box 120 described above can be used as a single wash box or in combination with one or more other wash boxes to form a washing range or a processing line. Further, one or more of the ultrasonic wash boxes 120 can be used with other process equipment that perform different functions to form a processing line for wet treatment of textile fabrics.

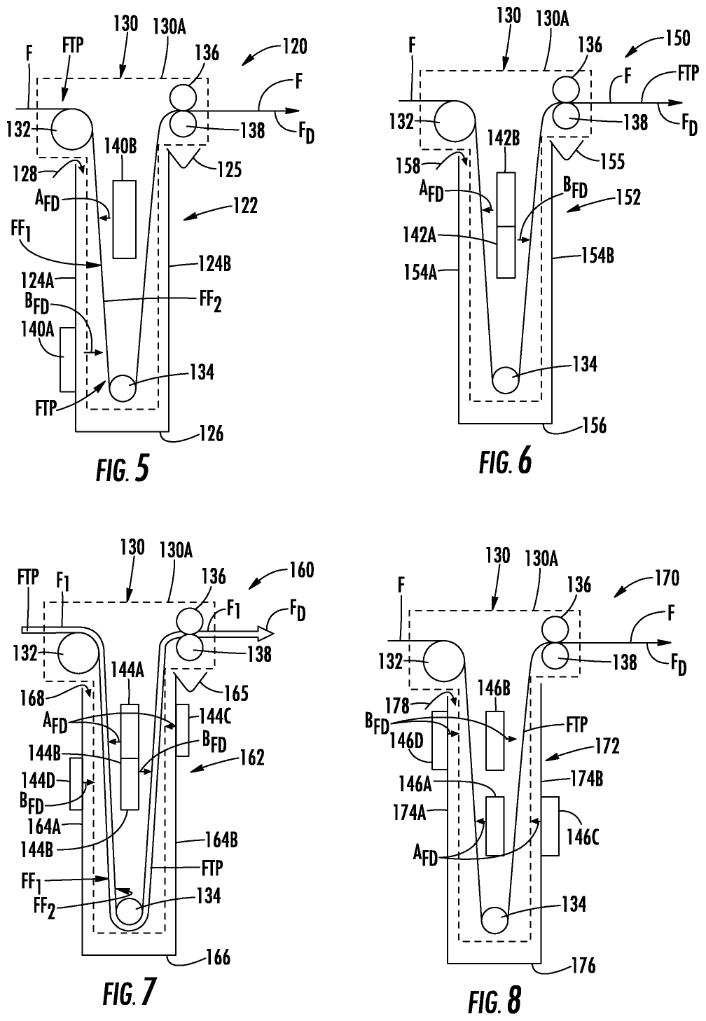

As shown in FIG. 6, a cross-sectional view of another wash box, generally designated 150, that can be provided which can be used to process conventional, single-layered fabrics or three-dimensional fabrics, such as 3-dimensional woven, tufted or knit fabrics or multiple layered fabrics. The wash box 150 can comprise a housing 152 having a first side wall 154A, a second side wall 154B, a first end wall and a second end wall (not shown in FIG. 6) as well as a bottom 156. As in other embodiments, the side walls 154A, 154B and end walls of the housing 152 form an upward facing opening 158 in the housing 152 in which the fabrics F be treated are processed. As with previous embodiments, the ultrasonic wash box 120 can comprise a fabric guide carriage 130 that can be inserted within the opening 128 of the housing 152 and into the well of the housing 152 between the first and second side walls 124A, 124B. The fabric guide carriage 130 can comprise a frame 130A that holds guide feed roller 132, which can be driven, a bottom guide roller 134, driven nip/squeeze rollers 136, 138 around which the fabric F can be looped to aid in forming the fabric travel path FTP through which the fabric F travels in direction F_{D}. By having no additional travel path rollers or guide bars so that the fabric only travels over the bottom positioned feed roller 132 and the around the bottom guide roller 134 and up to the driven squeeze rollers 136,138, a reduction in the change of directions the fabric F travels can occur that results in the reduction in the amount of tension placed on the fabric F.

The wash box 150 can comprise a first ultrasonic field generator 142A, which can be an ultrasonic transducer, and a second ultrasonic field generator 142B, which can also be an ultrasonic transducer, that are secured to the carriage 130 above the bottom roller 134. The first ultrasonic field generators 142A and the second ultrasonic field generators 142B on the carriage 130 can create dual, offset ultrasonic wave fields with the first ultrasonic field generators 142A positioned below the second ultrasonic field generator 142B on the carriage 130. In some embodiments, the positioning can be reversed with the first ultrasonic field generators 142A positioned above the second ultrasonic field generator 142B. Both the first ultrasonic field generator 142A and the second ultrasonic field generator 142B are insertable into the wash box and thereby the treatment fluid within the wash box when in use. For wash box 150 as shown in FIG. 6, the first ultrasonic field generator 142A and the second ultrasonic field generator 142B can be positioned to create an ultrasonic wave field that initially encounters the same face of the fabric F or, in the case of a fattened tubular circular knitted fabric, a same layer of the tubular fabric. Thereby, in such an arrangement, the wash box 150 is configured such that a single side of the fabric F receives an intensified treatment by initially encountering both ultrasonic wave fields first. As above, the ultrasonic field generators 142A, 142B can each emit an ultrasonic wave field in a range of frequencies and the intensities at which the ultrasonic field generators 142A, 142B can emit the ultrasonic wave fields at the specific frequencies can be adjustable. Once the ultrasonic wave field for each ultrasonic field generator 142A, 142B is selected for the specific use, each of the ultrasonic field generators 142A, 142B that will be implemented in the wash box 150 will be configured to emit the respective specified frequency. The power intensities of each ultrasonic field generators 142A, 142B described above can also be adjustable to change the intensity of the ultrasonic wave field created. For example, in some embodiments, the power intensities of each ultrasonic field generators 142A, 142B described above can be adjustable between about 0% to about 100% intensity.

Referring to FIG. 7, a cross-sectional view of a wash box, generally designated 160, is provided that is processing a fabric F₂, which is a multiple layered fabric or three-dimensional fabrics, such as 3-dimensional woven, tufted, nonwoven, high loft, or knit fabrics. While shown processing a 3-dimensional fabric F₁, the configuration of the wash box 160 provides better flexibility for processing simple, single-layers woven, knit, or nonwoven fabrics. The wash box 160 can comprise a housing 162 having a first side wall 164A, a second side wall 164B, a first end wall and a second end wall (not shown in FIG. 7) as well as a bottom 166. The side walls 164A, 164B and end walls of the housing 162 forms an upward facing opening 168 in the housing 162 in which the fabric F₁ to be treated can be inserted into a well of the housing 162 and processed. The first side wall 164A can be considered the face side and the second side wall 164B can be considered the rear side. Further, the ultrasonic wash box 160 can comprise a fabric guide carriage 130 that can be inserted within the opening 168 of the housing 162 between the first and second side walls 164A, 164B. The fabric guide carriage 130 can comprise a frame 130A (shown in dashed lines) that holds guide feed roller 132, which can be driven, a bottom guide roller 134, and driven nip/squeeze rollers 136, 138 around which the fabric F₁ can be looped to aid in forming the fabric travel path FTP through which the fabric F₁ travels in the direction F_{D}. By having no additional travel path rollers, the fabric only travels over the bottom positioned feed roller 132 and the around the bottom guide roller 134 and up to the driven squeeze rollers 136,138. This reduction in the change of directions the fabric F₁ travels can result in the reduction in the amount of tension placed on the fabric F₁.

The wash box 160 can comprise multiple ultrasonic generators. The wash box 160 can comprise a first ultrasonic field generator 144A and a second ultrasonic field generator 144B that are secured to the carriage 130 above the bottom roller 134. The first and second ultrasonic field generators 140A, 140B are inserted into the wash box and thereby the treatment fluid within the wash box when in use. The wash box 160 can also comprise a third ultrasonic field generator 144C secured to the first side wall 164A of the housing 162 and a fourth ultrasonic field generator 144D secured to the second side wall 164B of the housing 162. As stated above, the ultrasonic field generators 144A, 144B, 144C, 144D can include a protective housing around the ultrasonic transducers. The housings of the ultrasonic field generators 144A, 144B, 144C, 144D can be waterproof.

Each of the first and second ultrasonic field generators 144A, 144B can have a deflector plate on a side opposite of the side from which the ultrasonic wave field is emitted. For example, the first ultrasonic field generator 144A can comprise a deflector plate on a first side and projects an ultrasonic field from a second side in a first direction A_{FD} and the second ultrasonic field generator 144B can comprise a deflector plate on a first side and projects the ultrasonic field from a second side in a second direction B_{FD} that is opposite of the first direction A_{FD}. The third ultrasonic field generator 144C secured to the second side wall 164B of the housing 164 can be aligned with the first ultrasonic field generator 144A and emits the ultrasonic field in the first direction A_{FD}, while the fourth ultrasonic field generator 144D secured to the first side wall 164A of the housing is aligned with the second ultrasonic field generator 144B and emits the ultrasonic field in the second direction B_{FD}. For wash box 160, the first and second ultrasonic field generators 144A, 144B can be positioned to create an ultrasonic wave field that is primarily emitted to initially encounter a second face FF₂ of the fabric F₁ or, in the case of a fattened tubular circular knitted fabric, a first layer of the tubular fabric. The third and fourth ultrasonic field generators 144A, 144B can be positioned to create an ultrasonic wave field that is primarily emitted to initially encounter a first, opposing face FF₁ of the fabric F₁ or, in the case of a fattened tubular circular knitted fabric, a second layer of the tubular fabric.

The ultrasonic field generators 144A, 144B, 144C, 144D can each emit ultrasonic wave field within a range of frequencies and the intensities at which the ultrasonic field generators 144A, 144B, 144C, 144D can emit the ultrasonic wave fields at the specific frequencies can be adjustable. As explained above, once the ultrasonic wave field for each ultrasonic field generator 144A, 144B, 144C, 144D is selected for the specific use, each of the ultrasonic field generators 144A, 144B, 144C, 144D that will be implemented in the wash box 160 will be configured to emit the respective specified frequency. For example, ultrasonic field generators 144A, 144B, 144C, 144D can each emit an ultrasonic wave field within a range from about 10 kHz to about 120 kHz. In some embodiments, the ultrasonic field generators 144A, 144B, 144C, 144D can each emit an ultrasonic wave field within a range from about 15 kHz to about 100 kHz. In some embodiments, the ultrasonic field generators 144A, 144B, 144C, 144D can each emit an ultrasonic wave field within a range from about 20 kHz to about 80 kHz. In some embodiments, the ultrasonic field generators 144A, 144B, 144C, 144D can each emit an ultrasonic wave field within a range from about 25 kHz to about 40 kHz. In some embodiments, the ultrasonic field generators 144A, 144B, 144C, 144D that are implemented can be configured to emit an ultrasonic wave field of different frequencies. In some embodiments, the ultrasonic field generators 144A, 144B, 144C, 144D that are implemented can be configured to emit ultrasonic wave fields with the same frequency or similarly frequencies. The power intensities of each ultrasonic field generators 144A, 144B, 144C, 144D described above can also be adjustable to change the intensity of the ultrasonic wave field created. For example, in some embodiments, the power intensities of each ultrasonic field generators 144A, 144B, 144C, 144D described above can be adjustable between about 0% to about 100% intensity.

As shown in FIG. 8, a cross-sectional view of another wash box, generally designated 170, is provided which can be used to process conventional single-layered fabrics or multiple layered fabrics, as well as three-dimensional fabrics, such as 3-dimensional woven, tufted or knit fabrics. The wash box 170 can comprise a housing 172 having a first side wall 174A, a second side wall 174B, a first end wall and a second end wall (not shown in FIG. 6) as well as a bottom 176. As in other embodiments, the side walls 174A, 174B and end walls of the housing 172 form an upward facing opening 178 in the hosing 172 in which the fabrics F be treated are processed. As with previous embodiments, the ultrasonic wash box 170 can comprise a fabric guide carriage 130 that can be inserted within the opening 178 of the housing 172 and into the well of the housing 172 between the first and second side walls 1724A, 174B. The fabric guide carriage 130 can comprise a frame 130A that holds guide feed roller 132, which can be driven, a bottom guide roller 134, driven nip/squeeze rollers 136, 138 around which the fabric F can be looped to aid in forming the fabric travel path FTP through which the fabric F travels in direction F_{D}. By having no upper feed roller and additional travel path rollers so that the fabric only travels over the bottom positioned feed roller 132 and the around the bottom guide roller 134 and up to the driven squeeze rollers 136,138. This reduction in the change of directions the fabric F travels results in the reduction in the amount tension placed on the fabric F.

Similar to the embodiment shown in FIG. 7, the wash box 170 in FIG. 8 can comprise a first ultrasonic field generator 142A and a second ultrasonic field generator 146B that are secured to the carriage 130 above the bottom roller 134, but that are spaced apart. The first ultrasonic field generators 146A and the second ultrasonic field generators 142B on the carriage 130 can create dual, offset ultrasonic wave fields with the first ultrasonic field generators 142A positioned above second ultrasonic field generator 142B on the carriage 130 at a further distance from each other within the well of the housing 172. Both the first ultrasonic field generator 146A and the second ultrasonic field generator 146B are insertable into the wash box and thereby the treatment fluid within the wash box when in use. For wash box 170 as shown in FIG. 8, the first and second ultrasonic field generators 145A, 146B can be positioned to create an ultrasonic wave field that initially encounters a second face of the fabric F or, in the case of a fattened tubular circular knitted fabric, a first layer of the tubular fabric.

The wash box 170 can also comprise a third ultrasonic field generator 146C secured to the second side wall 174B of the housing 172 and a fourth ultrasonic field generator 144D secured to the first side wall 174A of the housing 172. As above, the first ultrasonic field generator 146A can comprise a deflector plate on a first side and projects an ultrasonic field from a second side in a first direction A_{FD} and the second ultrasonic field generator 146B can comprise a deflector plate on a first side and projects the ultrasonic field from a second side in a second direction B_{FD} that is opposite of the first direction A_{FD}. The third ultrasonic field generator 144C secured to the second side wall 174B of the housing 174 can be aligned with the first ultrasonic field generator 146A and emits the ultrasonic field in the first direction A_{FD}, while the fourth ultrasonic field generator 146D secured to the first side wall 174A of the housing is aligned with the second ultrasonic field generator 146B and emits the ultrasonic field in the second direction B_{FD}. The third and fourth ultrasonic field generator 146B, 146B can be positioned to create an ultrasonic wave field that initially encounters a first, opposing face of the fabric F or, in the case of a fattened tubular circular knitted fabric, a first layer of the tubular fabric. As explained in detail above with other embodiments, the ultrasonic field generators 146A, 146B, 146C, 146D can each emit ultrasonic wave field in a range of frequencies and the intensities of the wave field frequencies can be adjustable.

As within other embodiments described herein, the ultrasonic wash boxes 150, 160, 170 described above can be used as a single wash box or in combination with one or more other wash boxes to form a washing range or a processing line. Further, one or more of the ultrasonic wash boxes 150, 160, 170 can be used with other process equipment that perform different functions to form a processing line for wet treatment of textile fabrics.

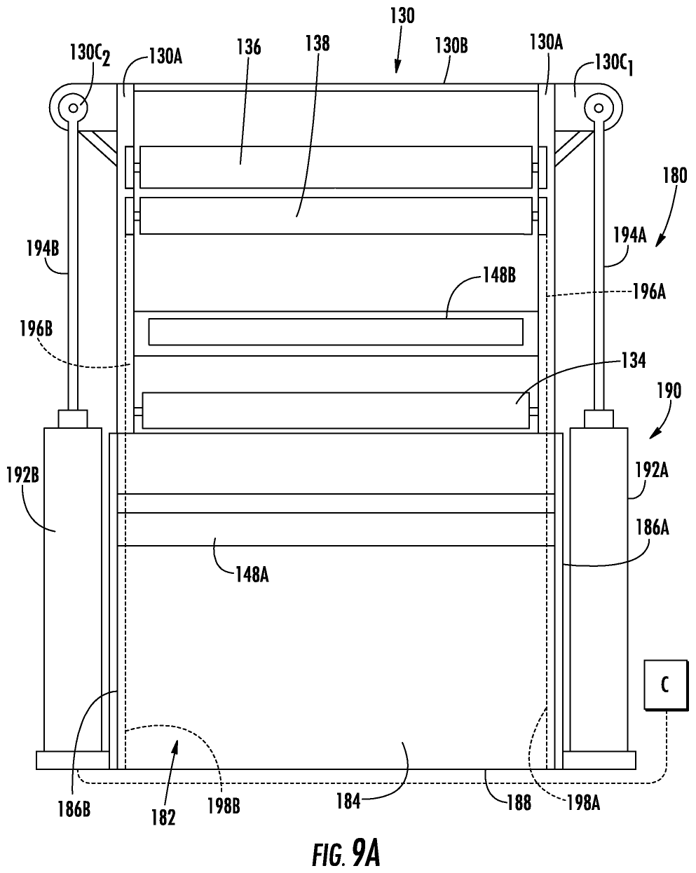

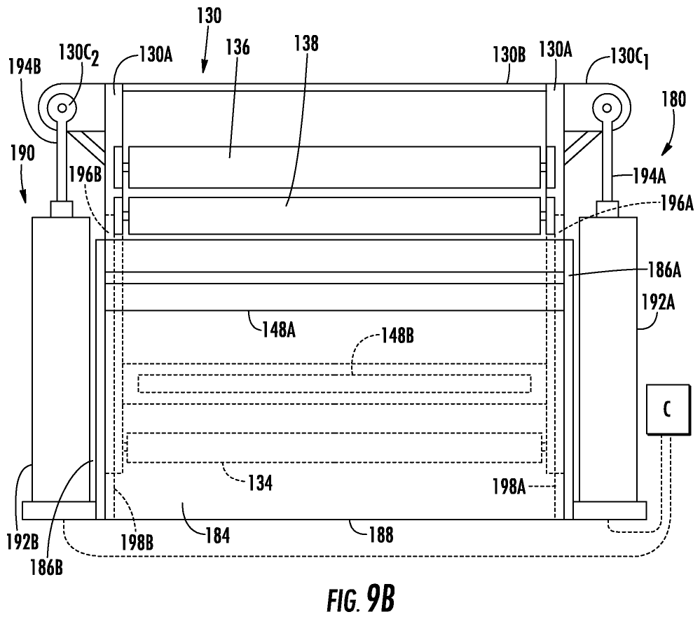

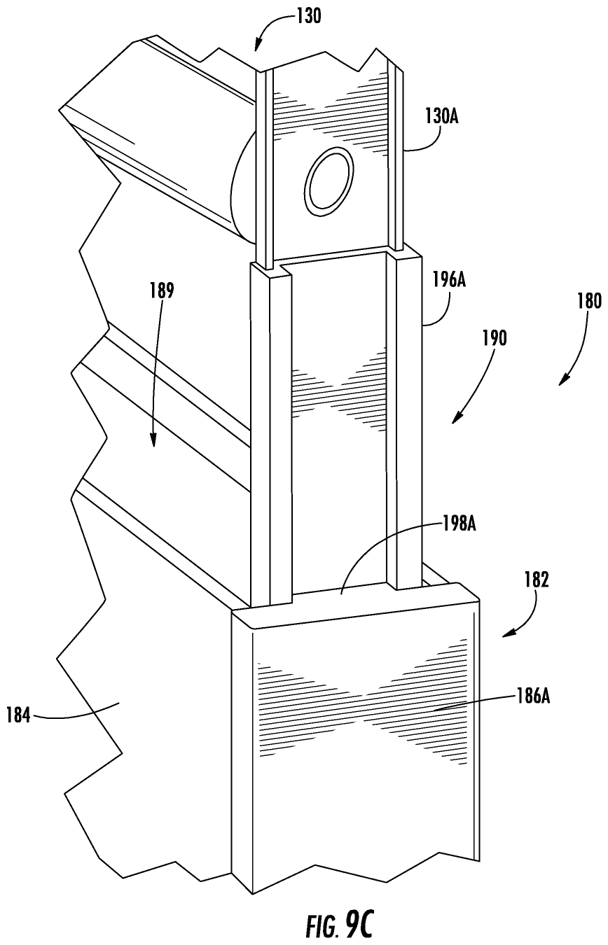

Referring to FIGS. 9A-9C, a front plan view of a wash box, generally designated 180, is provided that can be used to process fabrics in a fabric processing line. As shown in FIG. 9A, the wash box 180, which can be used with woven fabrics, can be provided that comprises a housing 182 having a first side wall (not shown), a second side wall 184, a first end wall 186A and a second end wall 186B as well as a bottom 188. The side and end walls 184, 186A, 186B of the housing 182 form a washing cavitation or well with an upward facing opening 189 (see FIG. 9C) in the housing 182 in which fabrics to be treated are processed. Further, the ultrasonic wash box 180 can comprise a fabric guide carriage 130 that can be inserted within the opening of the housing 182 between the first and second end walls 186A, 186B and the side walls. In the embodiment shown, the wash box 180 can also comprise one or more ultrasonic field generators 148A, which can be ultrasonic transducers, secured to the second side wall 184 or the first side wall of the housing 182. The fabric guide carriage 130 can comprise a frame 130A that holds rollers 134, 136, 138 around which a fabric to be treated can be threaded before insertion in the opening 189 and into the well of the wash box 180. The fabric guide carriage 130 can also comprise one or more brace bars 130B that can be used to stabilize the frame 130A. In some embodiments, the frame 130 can also comprise one or more ultrasonic field generators 148B that includes a housing that is secured to the frame 130A.

As shown in FIG. 9A, the wash box 180 can further comprise a carriage guidance system, generally designated 190, that is secured to the fabric guide carriage 130 to raise and lower the fabric guide carriage 130 in and out of the cavitation or well of the wash box 180. The carriage guidance system 190 can comprise a hydraulic system that lifts the frame 130 out of the cavitation or well of the wash box 180 to permit the threading of fabric around the rollers to form a fabric travel path through which the fabric travels when the frame is lowered by the carriage guidance system 190 into the wash box 180 as shown in FIG. 9B. For example, the carriage guidance system 190 can include a first hydraulic cylinder 192A having a cylinder arm 194A secured to the fabric guide carriage 130 at a first guidance connection portion 130C₁ of the frame 130A and a second hydraulic cylinder 192B having a cylinder arm 194B secured to the fabric guide carriage 130 at a second guidance connection portion 130C₂ of the frame 130A located on an opposite side of the frame 130A. The carriage guidance system 190 can also include a controller C, for example, a computer or a programmable logic controller, that can be in operable communication with the hydraulic cylinders 192A, 192B to simultaneously raise the cylinder arms 194A, 194B to raise the fabric guide carriage 130 to an upward, or threading, position as shown in FIG. 9A or to simultaneously lower the cylinder arms 194A, 194B to lower the fabric guide carriage 130 to a downward, or operating, position as shown in FIG. 9B.

The carriage guide system 190 can also comprise one or more receiving guides 196A, 196B having a groove or channel therein and one or more insertion guides 198A, 198B that correspond to the receiving guides 196A, 196B. As shown in to the embodiment illustrated in FIGS. 9a-9C, the receiving guides 196A, 196B can be on either side of the frame 130A and are configured to engage the insertion guides 198A, 198B on the end walls 186A, 186B. As shown, each of the insertion guides 198A, 198B can extend along the a substantial length of the respective end walls 186A, 186B and the insertion guides 198A, 198B can extend along a substantial portion of the both sides of the frame 130A. The receiving guides 196A, 196B and the insertion guides 198A, 198B add stability and guidance for the movement of the fabric guide carriage 130. In some embodiments, the insertion guides can be on the frame and the receiving guides can be on the end walls. Other types of male/female connections can be used within the carriage guidance system 190.

Through the utilization of ultrasonic technology as described above, the washing effect will be increased while the consumption of process media, i.e., water, steam and chemicals used in the respective processes, can be drastically decreased. Ultrasonic waves will increase the media exchange including the exchange of air (dry fabric) with water during a wash processes, such as scouring. For example, using the offset dual opposing ultrasonic transducers on a wash box, a user can expect reduction potentials for such medias. For example, using the offset dual opposing ultrasonic transducers on a wash box, the user can expect to use up to 50% less water compared to traditional wet processing. Using the offset dual opposing ultrasonic transducers on a wash box in a steam based process, the user can expect to use up to 50% less steam compared to traditional wet processing. Further, using the offset dual opposing ultrasonic transducers on a wash box, the user can expect to use less of the chemicals needed for a given process compared to traditional wet processing. The amount of chemicals saved will vary depending on the process and the kind of the chemical or chemicals used.

The ultrasonic wash boxes disclosed herein can be used for upgrades of existing wet or dry processing ranges, or processing lines, independent of the manufacturer as well as for full new wet or dry processing ranges. All wet processing steps are linked to a washing process which can include these ultrasonic wash boxes, including washing for desizing, after bleaching (hot/cold), after mercerizing, after dyeing (cold/pad steam), and after printing. Furthermore, these ultrasonic wash boxes can be used in washing steps that can include preparation-washing processes. An example would be preparation-washing process step used in processing fabrics which contain elastane fibers, such as Spandex® or Lycra® fibers. These ultrasonic wash boxes can be used in upgrades for all impregnation processes, including impregnation for desizing, bleaching, and possibly dyeing.

These ultrasonic wash boxes can be used in new continuous wet processes, for example, on washing ranges for desizing, washing after bleaching (cold), washing after dyeing, and washing after printing. Additionally, these ultrasonic wash boxes can be used for preparation washing ranges for the remove oils, fats, waxes used in spinning and weaving preparation as a further example. Other new continuous ranges such as bleaching ranges may also utilize these ultrasonic wash boxes. Especially in case of preparation washing processes, these ultrasonic wash boxes can be installed in a washing range in front of an existing tenter frames, which means that the fabric will be able to be washed, dried and heat-set “in-line”.

These ultrasonic wash boxes can be used with different types of fabrics including woven fabrics, knit fabrics and nonwoven fabrics. Fabrics comprising cellulosic fibers (cotton, viscose, e.g., rayon) can be treated in these ultrasonic wash boxes. Further, fabrics comprising synthetic fibers like polyester, and polyamide, etc., are also possible. Such fabrics may also comprise blends with elastic fibers (e.g., elastane fibers).

For woven fabrics, the elastane fiber content can the range between 2% and 10%. In woven fabrics, elastane fibers can be found mainly in weft-direction (or pick direction) but can be found in both directions (weft and warp). Such woven fabrics with elastane extending both directions are called bi-elastic woven fabrics. Weft-elastic fabric can have the tendency of curling edges especially in the first moment of contact with water. This curling is less likely to happen with bi-elastic fabrics. Bi-elastic fabric should be treated at a lowest possible tension level in order to avoid the destruction of elasticity within the ultrasonic wash boxes disclosed herein.

The normal fabric weight ranges for fabrics that can be processed within these ultrasonic wash boxes can vary. For example, fabric weight ranges can vary from very light fabrics (e.g., for curtains) with a minimum weight of 40 g/m² to a maximum weight of approx. 400 g/m² (e.g., denim). Terry towel can appear with higher weights as with bathroom carpets where the weight can be up to 1,500 g/m².

Knitted fabrics that can be processed in these ultrasonic wash boxes can include fabric for garments (shirts, sweaters). Such fabrics can comprise cellulosic fibers, such as cotton and viscose. Further, such fabrics can comprise synthetic fibers such as polyester and blends of cellulosic and synthetic fibers which can include Lycra (up to 10%) and/or polyester. Particularly for knitted fabrics that comprise a blend of cellulosic and synthetic fiber blends, a preparation washing process that utilizes these ultrasonic wash boxes can be useful.

Knit and woven fabrics comprising synthetic fiber material or uses such as in sportswear or for technical textile as e.g., automotive material for seats and roofing, can also be processed in these ultrasonic wash boxes. In the area of sportswear, blends of polyester or nylon with elastane fibers are commonly used. The elastane fiber content will be up to about 10%. In case of swimwear, the knitted fabrics can include an elastane fiber content that can be up to about 30%. For these knitted fabrics, a preparation washing process using these ultrasonic wash boxes can be useful since these yarns will be laden with oils from spinning preparations. Lycra yarns and fibers cause problems, in particular, since the fibers are generally laden with lots of silicone oils. The fabric weight in knits usually range from about 100 g/m² to about 400 g/m². Lighter weight or heavier weight fabric are possible appear but will be the exception.

In general, these ultrasonic wash boxes can operate between about 20 m/min. and about 60 m/min. depending on the types of fabrics being processed and the line speeds at which the broader process operates. In some embodiments, for example, these ultrasonic wash boxes can operate at faster speeds for processes lines for some types of material, such as bed sheeting, air bag material, and some nonwoven materials. In case of the preparation washing application in front of existing stenters, or tenter frames, the production speed can be dependent upon the speed of the stenters or tenter frames.

In some embodiments, these ultrasonic wash boxes can operate at very slow production speeds that range about 2 m/min. and about 20 m/min. depending the fabrics being processed and the processing speeds of the other equipment within the processing line. For example, digital printing application processing lines which are used for small capacities operate at slow speeds. In this case, these ultrasonic wash boxes can be useful can be installed “in line” with steamer units which is usually delivered by the printing machine manufacturer. Further, very slow production speeds are possible when treating 3-dimensional fabric such as corduroy, velveteen or carpets.

When installing these ultrasonic wash boxes within a processing line, the fabric flow is important for the layout of ranges. It can be calculated in the following way:

Q(fabric)=width (in m)*speed (in m/min)*weight (in kg/m2)*60 (min)

The result is displayed in kg/h.

Such a calculation can be useful in defining the path of the fabric within the processing lines and in particular within these ultrasonic wash boxes along with other considerations. For example, the path of the fabric and the method used for fabric guiding can be dependent on the individual properties of the different types of fabric. For instance, elastane containing fabrics and/or knitted fabric are tension-sensitive fabrics. With such fabrics, the drive system within the processing lines and particularly these ultrasonic wash boxes preferably operate in a way so as to minimize tension. Furthermore, in case of fabric with the tendency of curling edges, we need to provide suitable de curlers and fabric guiding elements within these ultrasonic wash boxes. Fabric tension is, however, not only influenced by the drive system, but also the selection of the right bearings and the seals within these ultrasonic wash boxes depending on the need for such components for the specific type of processing line and the fabrics being processed.

In traditional ranges, the liquor used within the wash box is guided through the wash box in counter-flow direction. This is done to increase the efficiency of the process water. The wash box should be configured such that the liquor flow inside the wash box and inside the whole range does not disturb the ultrasonic field and the cavitation that occurs.

The washing efficiency with the ultrasonic wash boxes disclosed herein can also be dependent on the ratio between the concentration of impurities in the fabric and the process water. The periodic exchanging of the process water within the wash box can help avoid a collection of impurities within the process water. Thus, it is helpful that the liquor should flow both inside the entire range and also inside each single wash box in opposite direction of the fabric travel path. Since ultrasonic technology is being used, however, a full counter flow can be avoided so to reduce the quantity of the liquor flow within each wash box. The solution might be to feed fresh water to each wash box but with reduced quantities. At the end the total consumption of water should not be higher than with a full counter flow.

The expected total water consumption within a process line can vary depending on the specific types of individual processes that comprise that line. Different processes can be expected to consume different amounts of water. For example, a desizing process can be expected to use about 1 to about 2 liters of water per kilogram of fabric. A washing process after bleaching can be expected to use about 2 to about 3 liters of water per kilogram of fabric. A washing process after a mercerizing process can be expected to use about 3 to about 4 liters of water per kilogram of fabric. A washing process after a screen printing process can be expected to use about 6 to about 8 liters of water per kilogram of fabric. Further, a preparation washing process can be expected to use about 2 to about 3 liters of water per kilogram of fabric.

The total water consumption is calculated using the below formula:

Q(water)=Q(fabric)*w

The result is displayed in l/kg.

With the ultrasonic wash boxes disclosed herein, normal temperature rules do not apply. Oxygen in the process-water disturbs the necessary cavitation energy delivered by the ultrasonic waves in the bath. With a temperature of at least 40° C., the oxygen inside the water can start a de-gassing process. Thus, a temperature of about 40° C. can usually be considered a minimum temperature of the liquor within the ultrasonic wash boxes for most applications. However, for a wet finishing process that specifically require colder temperature liquors, such as a cold mercerizing process in which the caustic soda containing liquor is applied with a temperature of about 20° C. or below, the temperature of the liquor can be below 40° C. Further, it has been found that the cavitation effect decreases as temperature rises. In particular, it has been found that the cavitation effect within ultrasonic wash boxes decreases as the temperature of the liquor rises above about 65° C. Thus, a maximum process temperature for the liquor within the ultrasonic wash boxes can be about 65° C. in most applications.

Depending on the process steps within a process line, certain chemicals can be added into the specific processes at specific times and quantities to achieve better processing results. Such dosing of chemicals can be maximized using the ultrasonic wash boxes disclosed herein. Generally speaking, there are three different ways on how to determine the dosing of chemicals during respective processes. It can be related to the water flow measured in ml/l water, the fabric flow measured in ml/kg fabric, or a signal of a sensor as such as a pH sensor for neutralization at the end of a range. In any case, the layout of the dosing pumps has to be calculated individually according to the fabric and water flow as well as the customer's recipes. The recipes can be clarified during the project phase and finally confirmed by the end user. The pump types can be decided individually according to the quantity, type of chemistry and the dosing principle.

Depending on the type of process in which the ultrasonic wash boxes are used, different types of chemicals are used. The types of chemicals that can be encountered in wet finishing processes including, but are not limited to, caustic soda and wetting agents, both of which is used more or less all types of wet processes and various kinds of acids, such as acetic acid or citric acid; but also preparations of various organic acids for all neutralization processes. These chemicals can also include peroxide or per-salts used in bleaching processes and in alkali treatments as preparation for bleaching, detergents that are used in washing and pretreatment processes, enzymes used in de-sizing and pretreatment processes, and salts used in dyeing processes and washing processes after dyeing. Further, these chemicals can include sequestrant/complexing/dispersing agents used in bleaching and dyeing processes and anti-foaming agents, which can be used in all possible processes. All these chemical products can be used individually or in combinations in recipes. For example, bleaching liquor preparations might contain 4 to 8 different chemical products including the basic chemicals as peroxide and caustic soda.

The ultrasonic wash boxes can optionally include a variety of other internal components and devices. For example, the ultrasonic wash boxes can comprise temperature control circuits that can operate in a continuous fashion (not on-off) and/or a heating system: The heating system can be direct or indirect. In some embodiments, an indirect heating system may be preferred because such heating systems do not change the concentration of the liquor in the wash box. This indirect heating systems can eliminate any possibility of contamination from chemical impurities in the general steam supply system. In some embodiments of the ultrasonic wash boxes that use an indirect heating system, the process water may be heated outside the wash boxes with a heat exchanger. Another option is that the customer delivers not water of at least 60° C. directly to the machine. In such embodiments, for example, an indirect heating system can be implemented to maintain a constant temperature of 60-65° C.

The ultrasonic wash boxes can also comprise level control circuits or level control systems. A level control system as used in these ultrasonic wash boxes can operate as a safety device to avoid the liquor running over the upper edges of the sides and ends of the wash boxes. The level control system can provide “on-off” function when the amount of liquor within the ultrasonic wash box gets too high, the level control system can turn off the equipment or turn off a pump providing the liquor or water to the wash box and in some embodiments, the level control system can turn the equipment or pump back on when the liquor level is within a proper range or below a maximum lever. Further, for embodiments where an ultrasonic wash box as disclosed herein is being used as an impregnation device, a level control circuit, or level control system, can also be used. For all these applications, the level of the liquor within the ultrasonic wash box preferably remains constant during the entire process. For this reason, the level control circuit, or level control system, can work in a continuous way when an ultrasonic wash box as disclosed herein is being used as an impregnation device.

The ultrasonic wash boxes as disclosed herein can also include a circulation system that operates in conjunction with the ultrasonic wash boxes to increase the effectiveness of the cleaning of fabrics within the specific process or process step. In particular, circulation systems can be used in ultrasonic wash boxes that are implemented as impregnation device, especially for a de-sizing process. The required chemical preparation can be fed into the liquor circulation system within the ultrasonic wash box. The liquor will be taken out of the box and fed into the same box in the same manner that a fresh water supply is fed when used as a wash box. The fresh water here in this case is part of the recipe and can be either dosed by an automatic dosing system can be does from a manual liquor preparation tank, where the recipe has been prepared previously and separately.

The ultrasonic wash boxes as disclosed herein can also include a dosing system that can be internal or external or both. This is for the preparation and dosing of chemicals outside of the box and used for impregnation processes. As stated above, on some embodiments, the dosing system for the ultrasonic wash boxes can be a manual liquor preparation in a tank beside the machine or in a preparation kitchen, which can be simple, but also can be inaccurate. This method of dosing can incorporate human error during the preparation of the liquor. Another type of dosing system is an automatic dosing system. In such a dosing system, chemicals for each for each preparation can be supplied to the dosing system from big external tanks through an automatic metering system. After mixing the products according to the recipe, the liquor preparation can be fed to the ultrasonic wash box and injected into the circulation system of the ultrasonic wash box.

The ultrasonic wash boxes as disclosed herein can also include a squeezing device. The squeezing device in ultrasonic wash boxes in continuous ranges can include two different functions. The squeezing device can help provide liquor separation as fabric being processed move between two wash boxes. Further, the squeezing device can help drive fabric being processed along the fabric travel path and can aid in piling the fabric through the respective wash boxes. In general, there are several types of squeezing devices that can be used with ultrasonic wash boxes. For example, the squeezing device can be a rubber-coated “jockey-roller” apparatus which are one or more rollers within a roller frame around which the fabric is laced. The jockey roller apparatus squeezes with the force supplied by the downward weight of the top roller against the either a nip surface or a nip roller. On some embodiments of the ultrasonic wash boxes, an intermediate driven squeezer can be used with a pneumatically controlled pressure roller. Such an intermediate driven squeezer can also be used between wash boxes in lieu of a jockey-roller. In some embodiments of the ultrasonic wash boxes, a high-efficiency squeezer can be used at the end of a wash box, range, or processing line. In some embodiments, a high-efficiency squeezer can be used at an impregnation box. In some embodiments, a pad can served as a high efficiency squeezer.

In some embodiments, the processing line that employ the ultrasonic wash box can also comprise a stenter frame, or tenter frame, with which the one or more ultrasonic wash boxes will need to be synchronized. For example, in process line embodiments for preparation washing processes, the one or more ultrasonic wash boxes might be installed to run “in line” with a stenter frame. In such embodiments, the one or more ultrasonic wash boxes within a wash range can be synchronized with the stenter frame, or tenter frame, such that the equipment starts, stops and operates at the same time and at the same operational fabric throughput speed along the fabric travel path. Therefore, a controller, such as a computer or programmable logic controller, for example, can be used in the processing line that establishes and can maintain communication between the ultrasonic wash boxes and the stenter during operation of the processing line. In some embodiments, the controller can provide controls or interfaces stop and/or an emergency stop of the processing line. In some embodiments, the controller can comprise a load cell or compensator/dancer roller system to create a signal to increase and decrease line speed.

The housing of the ultrasonic wash boxes can comprise a metal. For example, the housing can comprise stainless steel, such as SAE 316 stainless steel. The thickness of the walls of the housing of the ultrasonic wash boxes can vary depending on the type of process being performed within the wash boxes, the type of ultrasonic field generator being used and the frequencies in which the ultrasonic fields operate. In some embodiments, the thickness of the walls of the housing can vary. Without being held to any particular theory, however, it is believed that a thinner wall may better absorb the vibrations emitted by ultrasonic waves and or the direct heating system, if used.

Thus, the present disclosure as described above provides a method of treating a fabric that includes providing a wash box that comprises a housing having a first side wall, a second side wall, a first end wall and a second end wall. The housing has an opening formed between the side wall and the end walls and a fabric guide carriage insertable within the opening of the housing between the first and second side walls into an operating position. The wash box also comprises a first ultrasonic field generator and a second ultrasonic field generator positioned relative to the fabric guide when the fabric guide is in the operating position. The method includes threading a fabric in the fabric guide carriage such that the fabric passes through processing fluid within the housing when the wash box is in operation treating a fabric. A first ultrasonic wave field is generated with the first ultrasonic field generator within the processing fluid and a second ultrasonic wave field is generated with the second ultrasonic field generator within the processing fluid to treat the fabric traveling around the fabric guide. Thus a method is provided with the myriad variations described in detail above.

These and other modifications and variations to the present subject matter may be practiced by those of ordinary skill in the art, without departing from the spirit and scope of the present subject matter, which is more particularly set forth herein above. In addition, it should be understood the aspects of the various embodiments may be interchanged both in whole and in part. Furthermore, those of ordinary skill in the art will appreciate that the foregoing description is by way of example only, and is not intended to limit the present subject matter.

1. A wash box comprising:
a housing having a first side wall, a second side wall, a first end wall and a second end wall, the housing having an opening formed between the first and second side walls and the first and second end walls;
a fabric guide carriage insertable within the opening of the housing between the first and second side walls into an operating position such that a fabric that is being processed travels around the fabric guide; and
a first ultrasonic field generator and a second ultrasonic field generator positioned relative to the fabric guide when the fabric guide is in the operating position to treat the fabric traveling around the fabric guide.

2. The wash box according to claim 1, wherein the first ultrasonic field generator is secured to the first side wall of the housing and the second ultrasonic field generator is secured to the second side wall of the housing.

3. The wash box according to claim 2, wherein the first ultrasonic generator is positioned at a top portion of the first side wall of the housing and the second ultrasonic field generator is positioned at a lower portion of the second side wall of the housing wherein the first ultrasonic field generator is offset from the second ultrasonic field generator.

4. The wash box according to claim 2, wherein the second ultrasonic generator is positioned at a top portion of the second side wall of the housing and the first ultrasonic field generator is positioned at a lower portion of the first side wall of the housing wherein the first ultrasonic field generator is offset from the second ultrasonic field generator.

5. The wash box according to claim 1, wherein the fabric guide carriage is attachable to and removable from the housing.

6. The wash box according to claim 1, further comprises a guidance system for raising and lowering the fabric guide carriage so that the fabric guide carriage is removable from and insertable into the opening of the housing.

7. The wash box according to claim 6, wherein the first ultrasonic field generator is secured to the first side wall of the housing and the second ultrasonic field generator is secured to the fabric guide carriage.

8-9. (canceled)

10. The wash box according to claim 6, wherein the first ultrasonic field generator and the second ultrasonic field generator are secured to the fabric guide carriage.

11. The wash box according to claim 10, wherein the first ultrasonic generator is positioned at a lower portion of the fabric guide and the second ultrasonic field generator is positioned at a top portion of the fabric guide wherein the first ultrasonic field generator is offset from the second ultrasonic field generator.

12. The wash box according to claim 10, further comprising a third ultrasonic field generator secured to the first side wall of the housing; and
a fourth ultrasonic field generator secured to the second side wall of the housing.

13. The wash box according to claim 12, wherein the first ultrasonic field generator comprises a deflector plate on a first side and projects an ultrasonic field from a second side in a first direction and the second ultrasonic field generator comprises a deflector plate on a first side and projects the ultrasonic field from a second side in a second direction that is opposite of the first direction; and
the third ultrasonic field generator secured to the first side wall of the housing is aligned with the first ultrasonic field generator and emits the ultrasonic field in the first direction; and
the fourth ultrasonic field generator secured to the second side wall of the housing is aligned with the second ultrasonic field generator and emits the ultrasonic field in the second direction.

14-24. (canceled)

25. A fabric processing line comprising:
at least one wash box comprising:
a housing having a first side wall, a second side wall, a first end wall and a second end wall, the housing having an opening formed between the first and second side walls and the first and second end walls;
a fabric guide carriage insertable within the opening of the housing between the first and second side walls into an operating position such that fabric that is being processed travels around the fabric guide; and
a first ultrasonic field generator and a second ultrasonic field generator positioned relative to the fabric guide when the fabric guide is in the operating position to treat a fabric travels around the fabric guide.

26. The processing line according to claim 25, further comprising a second wash box comprising:
a housing having a first side wall, a second side wall, a first end wall and a second end wall, the housing having an opening formed between the first and second side walls and the first and second end walls;
a fabric guide carriage insertable within the opening of the housing between the first and second side walls into an operating position such that fabric that is being processed travels around the fabric guide; and
a first ultrasonic field generator and a second ultrasonic field generator positioned relative to the fabric guide when the fabric guide is in the operating position to treat a fabric traveling around the fabric guide.

27. The processing line according to claim 25, wherein the first ultrasonic field generator is on a top portion of the first side wall of the housing and the second ultrasonic field generator is on a lower portion of the second side wall of the housing such that the first ultrasonic field generator is offset from the second ultrasonic field generator.

28-31. (canceled)

32. The processing line according to claim 25, wherein the fabric guide carriage is removable from and insertable into the opening of the housing.

33. The processing line according to claim 32, wherein the first ultrasonic field generator is secured to the first side wall of the housing and the second ultrasonic field generator is secured to the fabric guide carriage.

34-35. (canceled)

36. The processing line according to claim 32, wherein the first ultrasonic field generator and the second ultrasonic field generator are secured to the fabric guide carriage.

37. (canceled)

38. The processing line according to claim 36, further comprising a third ultrasonic field generator secured to the first side wall of the housing; and
a fourth ultrasonic field generator secured to the second side wall of the housing.

39. The processing line according to claim 38, wherein the first ultrasonic field generator comprises a deflector plate on a first side and projects an ultrasonic field from a second side in a first direction and the second ultrasonic field generator comprises a deflector plate on a first side and projects the ultrasonic field from a second side in a second direction that is opposite of the first direction; and
the third ultrasonic field generator secured to the first side wall of the housing is aligned with the first ultrasonic field generator and emits the ultrasonic field in the first direction; and
the fourth ultrasonic field generator secured to the second side wall of the housing is aligned with the second ultrasonic field generator and emits the ultrasonic field in the second direction.

40. A method of treating a fabric, the method comprising:
providing a wash box comprising:
a housing having a first side wall, a second side wall, a first end wall and a second end wall, the housing having an opening formed between the first and second side walls and the first and second end walls;
a fabric guide carriage insertable within the opening of the housing between the first and second side walls into an operating position; and
a first ultrasonic field generator and a second ultrasonic field generator positioned relative to the fabric guide when the fabric guide is in the operating position;
threading a fabric in the fabric guide carriage such that the fabric passes through processing fluid within the housing;
generating a first ultrasonic wave field with the first ultrasonic field generator within the processing fluid and generating a second ultrasonic wave field with the second ultrasonic field generator within the processing fluid to treat the fabric traveling around the fabric guide.
